(19) United States
(12) Patent Application Publication
(10) Pub. No.: US 2011/0288991 A1
(43) Pub. Date: Nov. 24, 2011

(54) SYSTEM AND METHOD FOR AUTOMATED ISSUER-EFFECTUATED DIRECT DEPOSIT ENROLLMENT

(76) Inventors: Barry Kessler, New York, NY (US); Duane O. Jacobsen, (US); Steve A. Williams, (US)

(21) Appl. No.: 13/011,823

(22) Filed: Jan. 21, 2011

Related U.S. Application Data
(60) Provisional application No. 61/297,083, filed on Jan. 21, 2010.

(51) Int. Cl. G06Q 40/00

(52) U.S. Cl. 705/39

(57) ABSTRACT

A system and method are provided which provide the ability for third parties such as account issuers, for example, to easily initiate direct deposit enrollments on behalf of accountholders.

### CROSS-REFERENCE TO RELATED APPLICATIONS

This application claims the benefit of U.S. Provision Patent Application No. 61/297,083, filed on Jan. 21, 2010, the entire contents of which are incorporated by reference in their entirety.

### BACKGROUND OF THE INVENTION

1. Field of the Invention

This application relates to providing direct deposit enrollment services. In particular, this application relates to a system and method for allowing third parties such as card issuers and program administrators to facilitate direct deposit enrollment of accountholder customers.

2. Description of the Related Art

Currently, an accountholder who desires to receive funds via direct deposit initiates a direct deposit enrollment transaction through the payor that remits the money. The payor may be the employer of the payee or a governmental agency which provides for benefit entitlements. The accountholder payee typically completes a direct deposit authorization form which identifies the benefit and the desired routing and account number for depositing the payment. The payee typically provides this form to the payor for processing. This payee/payor-effectuated process can be complicated and burdensome for the accountholder. For example, the accountholder may be unfamiliar with or uncomfortable with the existing direct deposit enrollment process. This can be caused by a variety of factors. For example, distributed workforce employees often lack direct interaction with their company payroll administrator. This lack of direct interaction can lead to difficulty in achieving direct deposit enrollment. In the context of government benefits, it is not uncommon for recipients to be required to travel distances to find the appropriate agency resources to effectuate their direct deposit enrollment. Check-based federal benefit recipients can effectuate direct deposit enrollment electronically through the US Treasury “Go Direct” website (www.godirect.com), but that website's functionality is limited as it does not support existing direct deposit recipients seeking to re-direct their benefits from one deposit account to another. Effective Mar. 1, 2013, the “Go Direct” website will provide no further practical value when the Treasury eliminates all paper checks by requiring individuals receiving Social Security, Supplemental Security Income, Veterans, Railroad Retirement and Office of Personnel Management benefits to receive payments electronically.

### SUMMARY OF CERTAIN INVENTIVE ASPECTS

In a first embodiment, a method of automating enrollment of direct deposits from a payor to a payee's deposit account is provided. The method includes receiving payee deposit account information from an enrollment services client and generating direct deposit enrollment data from the received deposit account information. The method further includes storing the direct deposit enrollment data in a database and packaging the stored direct deposit enrollment data for transmission to a payor. At least a portion of the packaged enrollment data is then transmitted to the payor.

In another embodiment, an issuer-effectuated direct deposit enrollment system for automating enrollment of direct deposits from a payor to a payee's deposit account is provided. The system includes an enrollment processing and verification module configured to receive accountholder/payee information from the enrollment services client and determine the type of payor from which direct deposit is sought. The enrollment processing and verification module is further configured to store the accountholder/payee information as enrollment data, generate a enrollment data package for transmission, and transmit, based on the type of payor, the enrollment data package to the payor. The system further includes a return processing and verification module configured to receive data returned from the payor indicative of whether the payor successfully processed the enrollment data package, and also configured to process the received data and store the processed data as return data in a database. A deposit processing and verification module is also included which is configured to receive, from an issuing processor, data indicative of a successful completion of a direct deposit into a deposit account. The deposit processing and verification module is also configured to process the received data and store the processed data as deposit data. The system also includes a server configured to retrieve the stored enrollment data, return data, and deposit data; and execute computer instructions causing the retrieved data to be displayed to a user.

### BRIEF DESCRIPTION OF THE DRAWINGS

FIG. 1 is a block diagram of one example of a computing device that may be used in accordance with one or more embodiments.

FIG. 2 is a high-level network diagram of one example of an automated issuer-effectuated direct deposit system in accordance with one or more embodiments.

FIG. 3 is a more detailed view of the direct deposit enrollment system shown in FIG. 2.

FIG. 4 is a more detailed view of the direct deposit enrollment application server shown in FIG. 3.

FIG. 5 is a more detailed view of the enrollment protocol shown in FIG. 4.

FIG. 6 is a more detailed view of the enrollment data shown in FIG. 3.

FIG. 7 is a more detailed view of the transaction data shown in FIG. 6.

FIG. 8 is a more detailed view of the encryption processing from FIG. 3.

FIG. 9 is a more detailed view of the user data from FIG. 3.

FIG. 10 is a more detailed view of the event data from FIG. 3.

FIG. 11 is a more detailed view of the return data from FIG. 3.

FIG. 12 is a more detailed view of the deposit data from FIG. 3.

FIG. 13 is a flowchart showing one example of the process for an issuer-effectuated enrollment using the direct deposit system.

FIG. 14 is a flowchart providing a more detailed view of processing an enrollment relating to direct deposit of a federal benefit.

FIG. 15 is a flowchart providing a more detailed view of processing an enrollment relating to direct deposit of a paycheck from an employer via a payroll processor.

FIG. 16 is a flowchart providing a more detailed view of processing an enrollment relating to direct deposit of a state benefit.

FIG. 17 is a flowchart providing a more detailed view of processing an enrollment relating to direct deposit of a pension annuity.

FIG. 18 is a more detailed example of the process by which deposit data is stored in the enrollment system database.

FIG. 19 is flowchart showing process by which an enrollment services client is notified that an accountholder customer has canceled a direct deposit enrollment.

FIGS. 20A-20C provide an example of a client-issuer user interface for client-assisted benefit enrollment on the client user portal.

FIGS. 21A-21B provide an example of a batch upload interface.

FIGS. 22A-22C provide an example of an transactions management interface that may be used by an enrollment services client to manage and view enrollment transactions.

### DETAILED DESCRIPTION OF CERTAIN INVENTIVE EMBODIMENTS

Direct deposit is generally viewed as beneficial to both the payor and the payee. From the perspective of the payor, initiating a direct deposit eliminates the need to cut a paper check. Eliminating the use of the paper check creates various efficiencies. For example, using direct deposit reduces the risk of lost or stolen checks (which would require voiding the existing check and issuing a new check). Using direct deposit also typically costs less than it does to process paper checks. The payee also can similarly benefit from direct deposit. For example, the payee may avoid trips to a bank to deposit a paper check. In addition, because there are no paper checks, there are no checks to be lost or stolen. Moreover, payments reach the payee's account the day the check is issued.

The inventor of the embodiments described herein has recognized that, in addition to providing benefits to payors and payees, direct deposit enrollments can be beneficial to another party involved in direct deposit transactions; specifically the financial institution issuing the account. For example, because a direct deposit enrollment ensures regular deposits into an account, the issuing financial institution stands to benefit from increased deposits and extended accountholder life. As a result, the account issuer has an incentive to help facilitate the direct deposit enrollment of its accountholders. Issuers earn fees generated from account maintenance and transaction fees. In addition, in many instances, the deposit accounts that receive direct deposits are tied to payment network (e.g., Visa®, MasterCard®) debit cards. Issuers whose accounts are associated with these debit cards collect interchange fees from merchants who accept payments via these debit cards. If the account tied to the debit card receives regular deposits, the card associated with the account is more likely to be used on a regular basis, thereby resulting in increased fee income to the account issuer. Thus, the inventor has recognized that it would be an improvement to provide systems and methods which allow for the account issuer to initiate and manage direct deposit enrollments on behalf of the accountholder payee.

In accordance with various disclosed embodiments, a system and method are provided which provide the ability for third parties such as account issuers, for example, to easily initiate direct deposit enrollments on behalf of accountholders. There are various types of direct deposits that may be initiated using the systems and methods described herein. For example, automated enrollment for direct deposit of government benefits (such as social security) may be achieved using certain embodiments disclosed herein, and without needing to interface directly with the difficult process currently required. Additionally, automated enrollment for direct deposits of payroll checks may also be achieved using other disclosed embodiments. Still other embodiments provide for automated enrollment for direct deposit of state or local government benefits. Once the direct deposit enrollment has been initiated, direct deposits can be monitored and tracked in order to provide account issuers with program specific feedback and information relating to the effectiveness of their programs and the behavior of their accountholders.

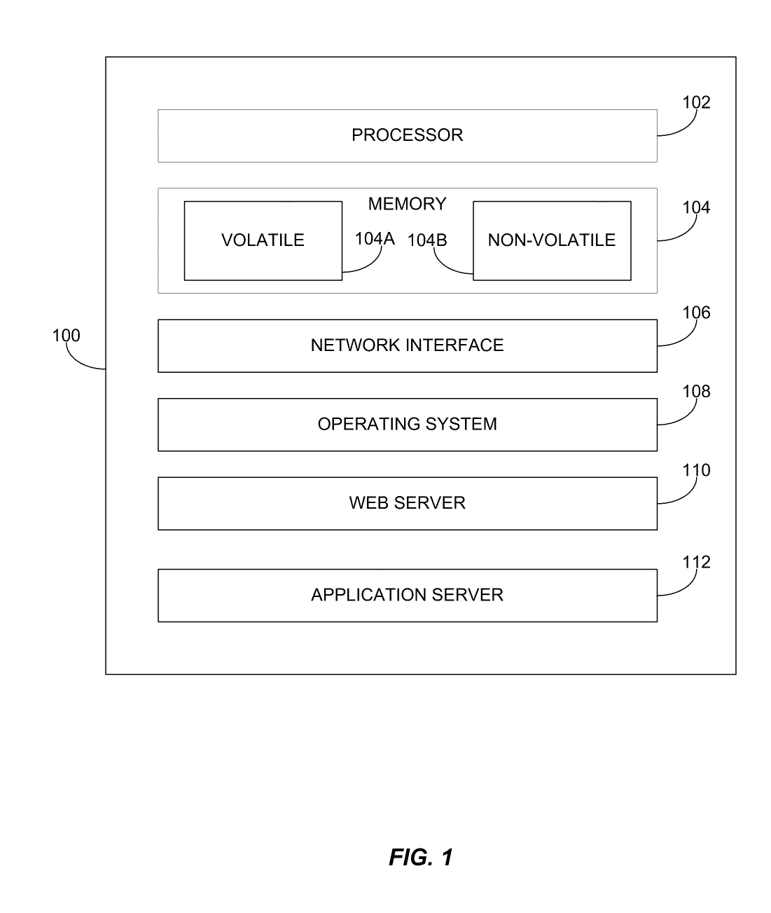

The systems and methods described herein may be performed by one or more computer systems. Turning to FIG. 1, an example is provided of a computer system 100 suitable for practicing various embodiments of the invention. The computer system 100 may generally take the form of computer hardware configured to execute certain processes and instructions in accordance with one or more embodiments described herein. The computer hardware may be a single computer or it may be multiple computers configured to work together. The computer system 100 includes a processor 102. The processor is generally configured to execute computer instructions to carry out certain tasks related to providing direct deposit enrollment services. The processor 102 may be a standard personal computer processor such as those distributed by Intel, Advanced Micro Devices or Motorola. The processor 102 may also be a more specialized processor tailored for banking processes and programs. The system 100 may also include memory 104. The memory 104 may include volatile memory 104A such as some form of random access memory. The volatile memory 104A may be configured to load executable software modules into memory so that the software modules may be executed by the processor 102 in a manner well known in the art. The software modules may be stored in a non-volatile memory 104B. The non-volatile memory 104B may take the form of a hard disk drive, a flash memory, a solid state hard drive or some other form of non-volatile memory. The non-volatile memory 104B may also be used to store non-executable data, such database files and the like.

The computer system 100 also may include a network interface 106. The network interface may take the form of a network interface card and its corresponding software drivers and/or firmware configured to provide the system 100 with access to a network (such as the Internet, for example). The network interface card 106 may be configured to access various different types of networks. For example the network interface card 106 may be configured to access private networks that are not publicly accessible. The network interface card 106 may also be configured to access wireless networks such using wireless data transfer technologies such as EVDO, WiMax, or LTE network. Although a single network interface card 106 is shown in FIG. 1, multiple network interface cards 106 may be present in order to access different types of networks. In addition, the network interface card 106 may be configured to allow access to multiple different types of networks.

An operating system 108 is also included in the computer system 100. The operating system 108 may be a well-known general operating system such as Linux, Windows, ChromeOS, or MacOS which is designed to provide a platform from which computer software applications may be executed by the processor 102. Alternatively, the operating system 108 may also be a special purpose operating system designed specifically for the network-based banking applications. Running on the operating system 108 may be web server software 110. The web server software 110 may be a standard off the shelf web server product such as Apache, Internet Information Server, or some other web server software. Alternatively, the web server may form a part of the operating system 108, or it may be a specialized HTTP server which is configured specifically to deliver banking related web pages to browsing software via a network such as the Internet, or some other local area network or wide area network. The web server software 110 may be stored in the memory 104 for access by the processor 102 to execute on the operating platform provided by the operating system 108.

The computer system, 100 further may include an application server 112. The application server 112 may include computer hardware and/or software which is configured to provide network-based applications which may run natively on the computer system 100, or be accessed via the web server 110, or both. The application server may be configured to allow for the distribution, use, and maintenance of a direct deposit enrollment system that will be discussed in detail below.

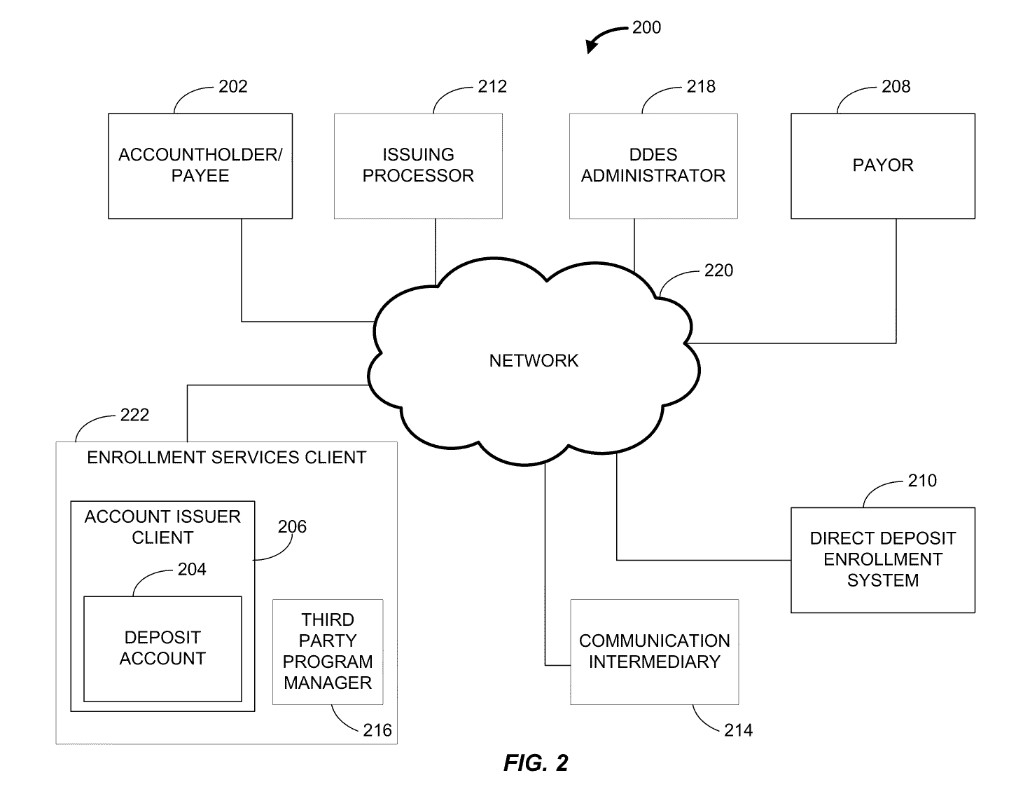

FIG. 2 is an example of a network environment suitable for practicing various embodiments described herein. The network environment 200 includes one or more networks 200. The network 220 may be a wide area network such as, for example, the Internet. The network 220 may also include a series of more localized networks, such as virtual private networks, or the like. The network 220 may also be a combination of private networks and public networks. In some embodiments, the network 220 is configured to support secure communications as is known in the art. For example, the network 220 may include a series of routers and other communications hardware and software which support various forms of encrypted communications. The network environment 200 may include various parties and systems which are in communication with each other via the network 220 in order to receive and/or provide direct deposit enrollment services.

For example, the network environment 200 may include an accountholder/payee 202. As used herein, the accountholder/payee 202 refers to a person or entity that is entitled to receive a payment and possesses a deposit account which can receive the payment. The payment is generally owed to the accountholder/payee 202 by a payor 208. As used herein, a payor 208 is a person or entity which makes a payment to the accountholder/payee 202. The accountholder/payee 202 may be an individual person, or it may be a business entity such as a corporation or a partnership. The payor 208 may be any of a variety of different types of entities. In one embodiment, the payor 208 may be the federal government, and the payment owed to the accountholder/payee 202 may be a federal benefit. In another embodiment, the payor 208 may be an employer, and the payment owed to the accountholder/payee may be a paycheck or some other payment. In other embodiments, the payor 208 may be a pension provider, and the payment owed to the accountholder/payee may be an annuity. In still another embodiment, the payor 208 may be a state or local government, and the payment owed to the accountholder/payee 202 may be a state or local benefit.

As noted above, systems and methods of disclosed embodiments relate to providing automatic direct deposit enrollment for accountholder/payees 202 in order to facilitate the payments made by the payor 208 to be directly deposited into one or more specified accounts. The accountholder/payee 202 may have one or more deposit accounts 204. The deposit account 204 may be viewed and transactions may be conducted via the network 220. The deposit account 204 may take various forms. The deposit account 204 may be a standard bank checking or savings account that is maintained at a bank. The deposit account 204 may also take the form of a prepaid debit card associated with a deposit account or some other type of stored value account. The deposit account 204 is typically associated with an account issuer client 206, although a decoupled prepaid debit card may also be used as a deposit account. As used herein, the account issuer client 206 refers to a party or entity which creates and/or issues the deposit account 204 for the accountholder/payee 202. In some embodiments, the account issuer is a traditional bank which creates a bank account for the accountholder/payee 202. In other embodiments, the account issuer client 206 may refer to an issuing bank which has issued a prepaid debit card.

Direct deposit enrollment services in the network environment may be provided by a direct deposit enrollment system 210. The direct deposit enrollment system 210 can be used to initiate a variety of different direct deposit transactions between the payor 208 and the payee 202 using various third party intermediaries 214 and without requiring direct contact and/or cooperation between the payor 208 and the payee 202. The direct deposit enrollment system 210 may be used to provide issuer-effectuated direct deposit enrollments in a variety of ways. However, in each instance, the direct deposit enrollment system is configured to enable the account issuer client 206 to collect the appropriate information (e.g., the necessary payee 202 information) to initiate direct deposit, verify the accuracy and reliability of the collected information, and then transmit the collected information to the appropriate party (e.g., payor 208) in order to complete the direct deposit enrollment.

The network environment 200 also may include a third-party program manager 216 managing a portfolio of deposit accounts 204 pursuant to a business and/or contractual relationship with the account issuer client 206. The third-party program manager 216, on behalf of the account issuer client 206, may be tasked with assisting accountholder/payees 202 in enrolling in direct deposit for their associated deposit accounts 204 using the direct deposit enrollment system 210. To that end, the third-party program manager 216 may collect and access data on behalf of the account issuer client 206, in order to provide the data necessary to the direct deposit enrollment system 210 for creating a direct deposit enrollment transaction. Collectively, the account issuer client 206 and the third-party program manager 216 may be referred to as the enrollment services client 222. The third-party program manager 216 may be the account issuer client itself. The enrollment services client 222 may also be associated with an issuing processor 212. The issuing processor 212 may be associated with the enrollment services client 222. The issuing processor 212 typically provides a processing platform that maintains account balance information and processes payment transactions involving debit cards and other network-access mediums associated with the deposit account 204.

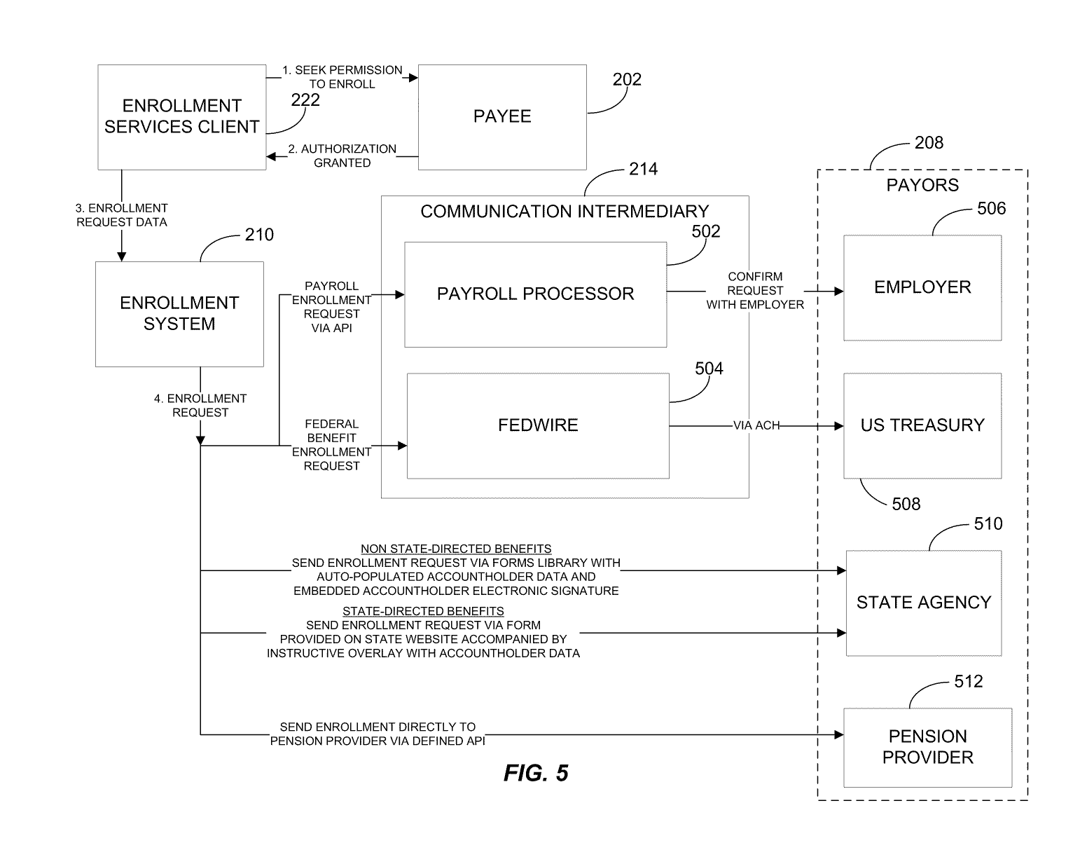

The network environment 200 may also include various communication intermediaries 214. The communication intermediaries 214 are generally entities which facilitate the transmission of a direct deposit enrollment between a payor 208 and the payee 202 using the direct deposit enrollment system 210. More details about the communication intermediaries 214 are provided below in connection with FIG. 5.

The network environment 200 may also include an administrator 218. The administrator 218 may be tasked with maintaining and administering the direct deposit enrollment system 210. The administrator 218 manages the direct deposit enrollment system 210 by creating and maintaining user accounts and permissions for enrollment services clients 222 using the system. The administrator 218 may also participate in setting up enrollment transactions between the direct deposit enrollment system 210 and the payor 208 through the communication intermediary 214.

The direct deposit enrollment system 210 eliminates the requirement that payors 208 and payees 202 directly interface to initiate direct deposit on an account. In doing so, the direct deposit enrollment system 210 allows for more efficient and reliable enrollment of deposit accounts to receive direct deposit of benefits and payments. By creating a network environment 200 suitable for facilitating these enrollment transactions, other parties such as the enrollment services client 222 and issuing processor 212 are able to reap ancillary benefits of the direct deposit enrollment such as increased fee income and revenue.

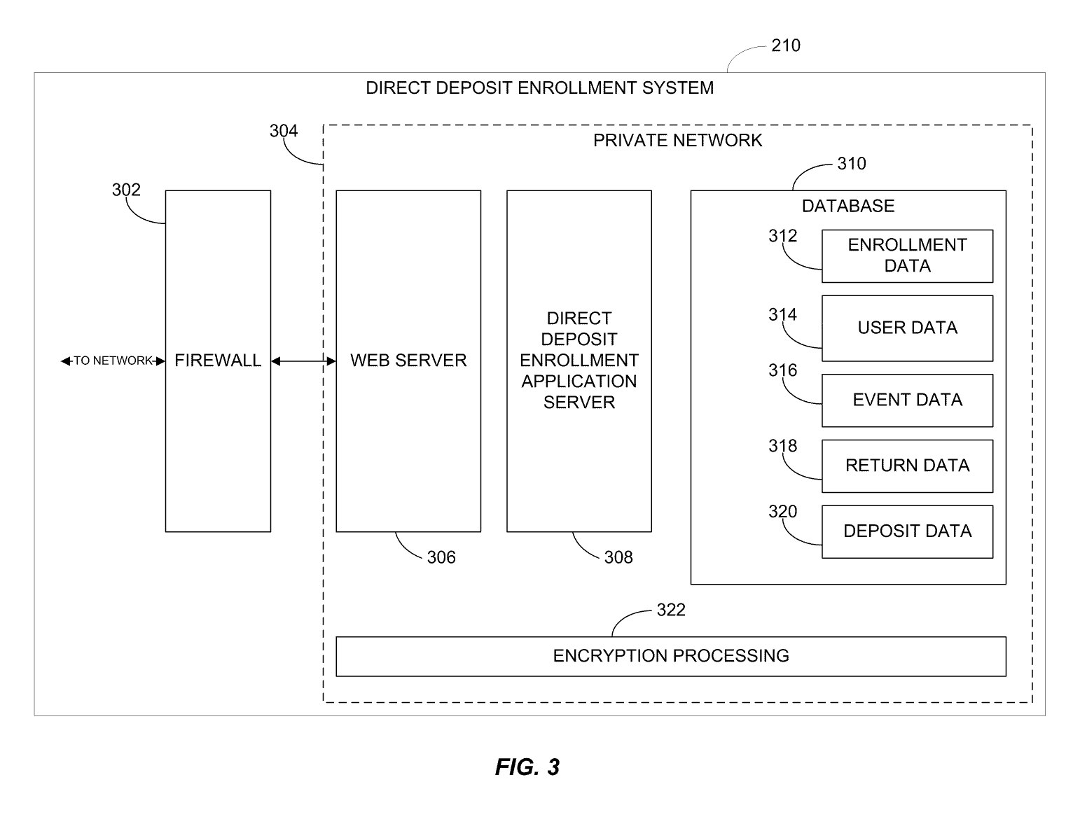

FIG. 3 provides a more detailed view of the direct deposit enrollment system 210 shown in FIG. 2. In the embodiment shown, portions of the direct deposit enrollment system 210 are situated within a private network 304 which is protected from open access to the Internet by a firewall 302. The use of the private network 304 and the firewall 302 helps to ensure that personal and confidential data is protected by requiring that system users have appropriate and necessary credentials to access the direct deposit enrollment system 210. Within the private network 304 is a web server 306. The web server generates web pages that may be accessed by users of the enrollment system 210 to initiate direct deposit enrollment transactions. The web server 306 may be configured to communicate with a direct deposit enrollment application server 308. The direct deposit enrollment application server 308 may take the form of a middleware application server provides an interface between the web server 306 and a database 310. As will be discussed in detail below, the direct deposit enrollment server 308 includes various modules which provide the ability to generate, process, verify, secure, and store enrollment transactions. In the embodiment shown in FIG. 3, the direct deposit enrollment application server 308 receives data from the web server 306, and based on the data received from the web server 306 may execute one or more application modules and/or initiate database operations (such as SQL queries, for example) on the database 310.

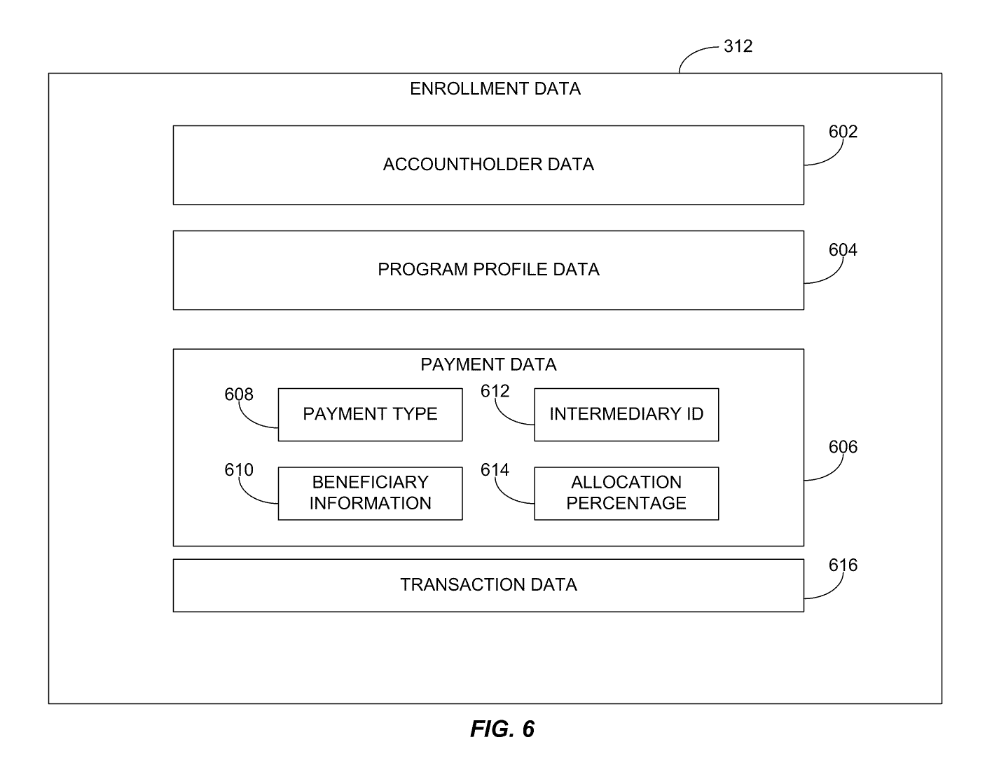

The database 310 may take the form of a relational database that is known in the art. The relational database may be in a format provided by off the shelf database software such as Oracle, MySQL, MS SQL Server or the like. The database 310 may store data related to the direct deposit enrollment transactions initiated by the direct deposit application server 308. For example, the database 310 may include enrollment data 312. The enrollment data 312 includes detailed information about each specific direct deposit enrollment initiated by the direct deposit application server 308, and will be described in further detail in connection with FIG. 6 below.

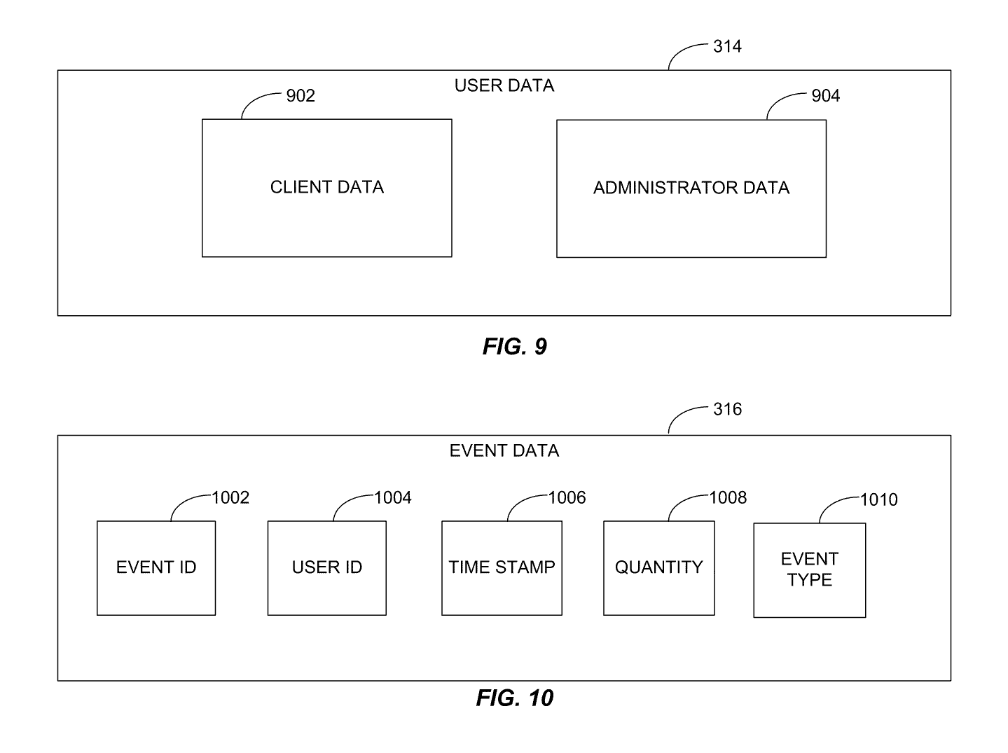

The database may also store user data 314. The user data 314 generally includes data relating to users of the direct deposit enrollment system 210. These users may include enrollment services clients 222 and the administrators 218. The user data 314 will be described in further detail in connection with FIG. 9 below. In addition, the database 310 may also store event data 316. The event data 316 typically includes information about transactions which take place as part of the direct deposit enrollment process, and will be discussed in additional detail below in connection with FIG. 10.

The database 310 may also store return data 318. Return data 318 is data that is received by the enrollment application server 308 in response to a request by the enrollment application server 308 to the payor 208 to enroll a payee 202 in direct deposit. In most instances, the return data 318 includes error codes and/or transaction codes which indicate whether the enrollment request was successful or not. The return data 318 may be processed by the application server 308 to modify and resubmit a request when the initial request for direct deposit enrollment fails.

In some embodiments, the direct deposit enrollment system 210 may be configured to capture deposit data that results from direct deposit enrollments initiated by the system 210. In these embodiments, deposit data 320 may be captured and stored in the database 310. In some embodiments, the deposit data 320 may be obtained directly from the issuing processor 212, which is typically responsible for posting deposits to deposit accounts 204. In other embodiments, the deposit data 320 may be first obtained by the enrollment services client 216 from the account issuer 206, and then provided to the direct deposit enrollment server 308.

In addition to the database 310, the enrollment server 308 may include encryption processing 322. The encryption processing 322 is generally used to encrypt data before it is stored in the database, and to decrypt data when it is retrieved from the database. The encryption processing 322 allows for stored data to be more secure.

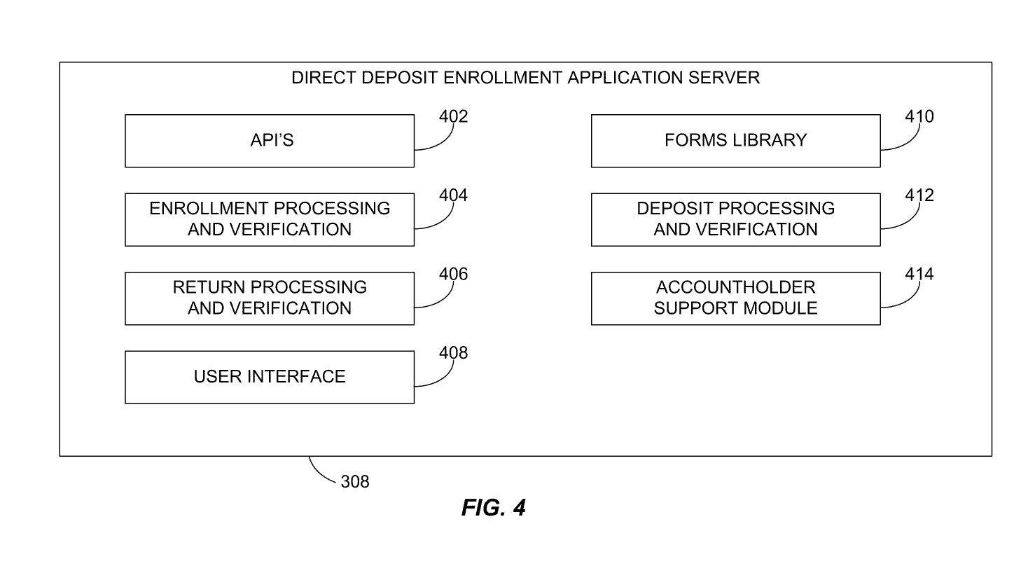

Turning now to FIG. 4, a more detailed view of the direct deposit enrollment application server 308 is provided. As shown, the enrollment application server 308 may include a plurality of APIs 402. Some of the APIs 402 may be enrollment APIs which provide interfaces allowing for enrollment data to be received by the enrollment application server 308 from an external application. For example, an enrollment services client 222 may access an enrollment API to submit enrollment data for an accountholder/payee being enrolled in direct deposit via the enrollment system 210. In some embodiments, enrollment APIs 402 allow for the creation of specific client-side environments which are suited to the needs of the particular client (such as the enrollment services client 222, for example) accessing the enrollment system 210 via the API 402.

The enrollment APIs 402 may be used to collect and compile enrollment data at the client, and then submit the data to the enrollment application server 308 via a series of API calls. In one or more embodiments, the data passed via the API calls includes enrollment data 312. The enrollment application server 308 receives the API data passed from the client and provides the received data to the enrollment processing and verification module 404. The enrollment processing and verification module 404 is configured to appropriately process the received data, as well as verify the credentials of the sender of the data and the accuracy of enrollment data received via the enrollment API 402.

In some embodiments, the processing includes sending the enrollment data to the payor 208. As will be discussed below in connection with FIG. 5, there may be various different types of payors 208 which are handled differently by the enrollment processing and verification module 404. In some instances, the payor 208 may be an employer of an accountholder/payee 202 such that the processing may include transmitting the received data through a communication intermediary such as a payroll processor 502, or some other intermediary 214. In other embodiments, the payor 208 associated with a submitted enrollment may be the U.S. Treasury, which owes a benefit (such as a Social Security check) to the payee 202. In these instances the processing may involve transmitting an enrollment request via a different communication intermediary 214. In still other scenarios, a communication intermediary 214 may be unnecessary, and the processing module 404 will send data directly to the payor 208. It is to be appreciated, of course, that the enrollment application server 308 may perform various additional steps in the course of processing the enrollment.

Generally, the payor 208 or other party receiving the enrollment data will perform its own processing on the enrollment data. If the enrollment request encounters errors, a return code may be provided to the enrollment application server 308 which is indicative of the error. For example, if an enrollment is transmitted via the Fedwire 504 of the ACH network to the federal government, and the ACH network request is refused, a return code may be sent to the enrollment application server 308 notifying it of the failed request. The enrollment application server 308 may include a return processing and verification module 406 which is configured to process and verify returns. If a return code indicates an error, the return processing module 406 may correct the error automatically and make a second request to the payor 208. Alternatively, the return processing module 406 may also ask the enrollment services client 222 which submitted the enrollment to take corrective action. If the return data contains no errors, an API response may or may not (depending on the processing protocol of payor 208) be sent back to the requesting party indicating that a successful enrollment transaction took place.

In addition to providing APIs 402 which allow external applications to interface with it, the application server 308 may also include one or more user interfaces 408 which allow a user to access the system via the web server 306. The user interfaces may include an administrator portal, a client portal, and a self service enrollment portal. The administrator portal include a user interface which allows the administrator 218 to create and manage user accounts, define reports, and perform other administrative tasks as required by the enrollment system 210. The client portal, which will be described in detail below, provides the enrollment services client 222 with the ability to view and modify enrollments, determine enrollment status, view deposit data, and the like. In addition, a self service enrollment portal may be defined which allows the payee 202 himself to submit a direct deposit enrollment request to the payor 208.

In some instances, an enrollment services client 222 using the enrollment system 210 may not choose to use (or may not have available to it) an API 402 to provide payee data for initiating a direct deposit enrollment. In these instances, in addition to (or in conjunction with) the user interfaces 408, a forms library 410 may be used to provide an input mechanism for enrollment data. The forms library may include one or more forms which allow a user to submit enrollment data to the enrollment application server 308 via web form pages served by the web server 306. The forms library 410 provides a convenient and accessible alternative to using the API services.

Additional APIs 402 may also be provided which allow the application server 308 to easily receive and process return data. For example, the application server may include an API which allows it to receive return codes from a communication intermediary 214 or payor 208 directly to store as return data 318. In addition, the application server 308 may also utilize an API to obtain deposit information from the issuing processor 212 to store as deposit data 320.

When a direct deposit enrollment has been successfully initiated, in some embodiments, the enrollment server 308 may be configured to track deposits made to deposit accounts 204. In order to track deposits, the enrollment server 308 includes a deposit processing and verification module 412. The deposit processing and verification module 412 may serve two purposes. First, it may be used to capture pre-notes to validate that a particular enrollment has been accepted by the payor 208. If a payor 208 has pre-noted a deposit account 204, it is an indication that the enrollment has been accepted by the payor 208. The pre-note data may include the zero dollar amount and the pre-note date and the payor information. In addition, deposit data may be also be captured in order to track total deposits achieved for a particular accountholder. This information allows the enrollment services client 222 to view and analyze the impact of their direct deposit enrollment activities, the enrollment/deposit lifecycle of their accountholder/payees 202 so that they may better understand and support them. Lastly, the application server 308 may also include an accountholder support module 414. The accountholder support module 414 provides assistance to accountholders/payees 202 wishing to effectuate direct deposit enrollment via the direct deposit enrollment system 210.

Turning now to FIG. 5, a more detailed view of data and process flow that takes place in a direct deposit enrollment is provided. As shown, the enrollment services client 222 initially requests permission from the accountholder/payee 202 to enroll them in direct deposit, and the accountholder/payee 202 provides his authorization, along with the necessary details to effectuate the enrollment. It should be appreciated that the enrollment services client 222 may already have most, if not all, of the necessary information from the payee 202 based on its relationship with the account issuer 206 and the issuing processor 212. The enrollment services client 222 accesses the direct deposit enrollment system 210 and provides it with the enrollment request data. The enrollment system, in turn, generates and submits an appropriate enrollment request based on the type of payment/benefit that is owed to the payee 202.

Depending upon the type of benefit and the nature of the payor, the process flow undertaken by the enrollment system 210 will differ. In the example shown in FIG. 5, four different scenarios are shown: (1) employer/employee payroll enrollment; (2) federal benefit enrollment; (3) state benefit enrollment; and (4) insurance annuity enrollment. A skilled artisan will appreciate, however, that various other payor/payee scenarios can exist, and that the particular examples shown in the figure should not be considered as limiting.

In the first employer/employee payroll enrollment scenario, the enrollment system 210 may utilize a communication intermediary 214 such as a payroll processor 502. The enrollment system 210 may communicate the enrollment request to the intermediary payroll processor 502, which in turn confirms the request with the employer 506 (who is the actual payor 208). In the federal benefit enrollment scenario, an intermediary 214 may also be used. In this scenario, the payor 208 is the U.S. Treasury 508, and the intermediary is the Fedwire 504 provided by the Treasury 508 for conducting ACH transactions. Thus, the enrollment request is sent to the Treasury 508 via the Fedwire 504 to effectuate the enrollment.

In the third scenario outlined in FIG. 5, the enrollment system is configured to handle a direct deposit enrollment request relating to a state benefit (such as an unemployment benefit, for example). In this context, the benefit may be a state directed benefit or a non-state directed benefit. For a non-state directed benefit, the enrollment request may be send using a form library with automatically populated accountholder data and an embedded electronic signature obtained from the accountholder/payee 202. In the case of a state directed benefit, the system 210 may direct the accountholder/payee 202 to send an enrollment request via a form provided on the state website accompanied by an instructive overlay with accountholder data. In either case, the use of an intermediary 214 is unnecessary, and the enrollment system 210 is configured to facilitate the effort of the accountholder/payee 202, capture the appropriate enrollment request data 312 into the state form and submit it to the state agency 510 directly for processing and enrollment.

In the fourth scenario, the enrollment request relates to an annuity paid by a pension provider 512. Here, the request by the enrollment system 210 may be generated to confirm to a predefined API that allows the request to be submitted directly to the pension provider 512. Alternatively, if the pension provider 512 utilizes a payment processor as a communication intermediary (not shown in FIG. 5), the request may be sent to the payment processor. As can be seen, there are many different ways in which the enrollment system may process data to effectuate direct deposit enrollments on behalf of the enrollment services client 222.

As noted above, the database 310 may receive enrollment data 312 via the application server 308 from either an accountholder 202 directly via the self service enrollment portal or an enrollment services client 222. FIG. 6 is a more detailed view of the enrollment data 312 that may be stored in the database 310. As noted previously, the enrollment data 312 generally includes data related to a specific enrollment in direct deposit services provided by payors 208 (either directly or in cooperation with intermediaries 214 such as payroll processor 502). The enrollment data 312 may include accountholder data 602. The accountholder data 602 typically includes information relating to the accountholder who wishes to enroll in direct deposit. This information may include an account number for the deposit account 204 associated with the customer. This information may also include the customer's name, address, e-mail, and other personal information.

An enrollment may also be associated with a particular program profile defined on behalf of an enrollment services client 218. The enrollment data 312 may include program profile data 604. The program profile data 604 may include information such as the routing number associated with the program, the branding associated with the program, and other program specific information. Also included in the enrollment data is the payment data 606. The payment data 606 is data which describes the details of the particular payments that are to be made in connection with a direct deposit enrollment. For example, the payment data 606 may include the payment type 608 (e.g., payroll, annuity, federal benefit, state benefit, etc.); beneficiary data 610 in cases where the accountholder/payee 202 may have a fiduciary relationship with the beneficiary and receive payments on its behalf; third-party intermediary information 612 for those situations where the direct deposit is performed by a third party intermediary 214 on behalf of the payor 208 (e.g., payroll processor 216); and specification of the allocation percentage 614 where a payee 202 wishes to direct deposit only a portion of payment to the designated deposit account 204.

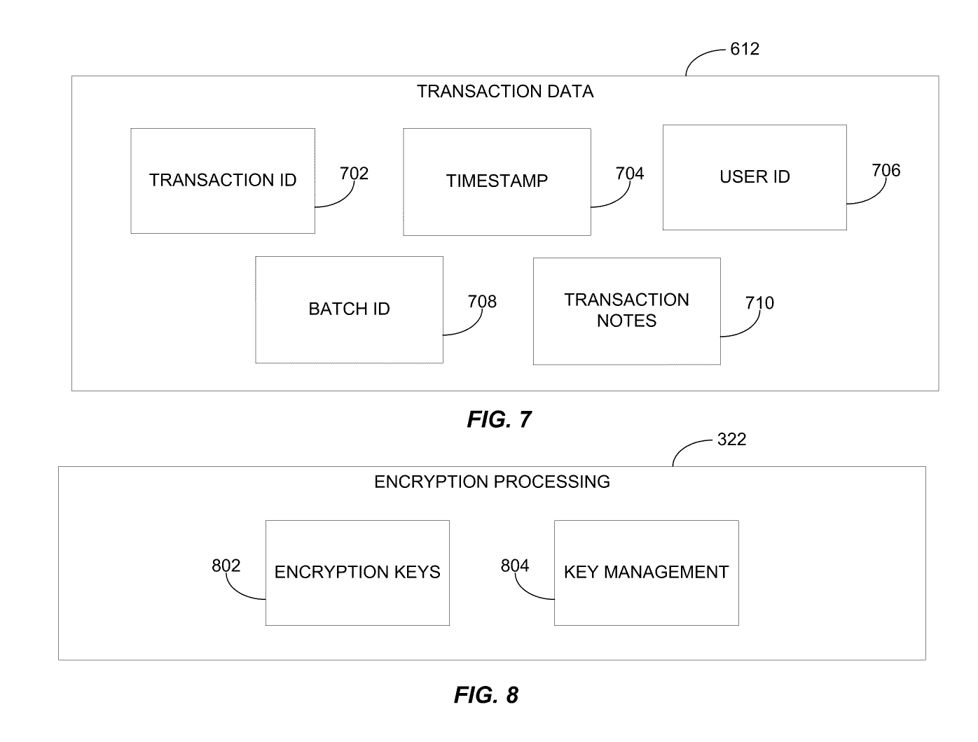

The enrollment data 312 stored in the database 310 may also include transaction data 616. The transaction data 616 is typically data relating to the receipt of new enrollment data into the direct deposit enrollment system 210. FIG. 7 provides information detail tracking the enrollment transaction data 616 provided. As shown, the transaction data 616 includes a transaction identifier 702. The transaction identifier 702 is an identifier which can be used to uniquely identify any single transaction that is stored in the database. The transaction data 616 may further include time stamp data 704. The time stamp data is generally used to provide a temporal context to the data. The transaction data 616 may further include user information 706. The user information 706 provides the identity of the particular user that initiated the transaction in the system. The user information may identify an administrator 218 entering enrollment data 612, or a client identifier where action is taken by the accountholder 202 directly or by an enrollment services client 222 on its behalf. The transaction data 616 may also include a batch identifier 708. The batch identifier 708 is to organize enrolled transactions which were submitted into the system using a batch process.

In some embodiments, the system 210 may be configured to pay out sales commissions to the initiator of the enrollment transaction based on the number of enrollments that they initiate. Thus, in these embodiments capturing the user identifier 706 allows for the enrollment services client 222 to gauge, evaluate and reward their performance.

Turning now to FIG. 8, a more detailed view of the encryption processing 322 from FIG. 3 is provided. The encryption processing 322 typically includes encryption keys 802 and one or more key management modules 804 which are used to appropriate assign and manage the keys to user accounts stored in the user data 314. In one embodiment, each user account is associated with a unique 32 character encryption key which is used to encrypt sensitive data (such as enrollment data 312, for example). These encryption keys may be stored in key storage. The sensitive data is generally stored encrypted to ensure its security. The key management module 804 may perform encryption using one or more encryption scripts which incorporate a triple DES cipher. Because the encryption is user account specific, only the specific user account associated with the encrypted data (or an administrator 218) can access the sensitive data once it has been encrypted.

As discussed in connection with FIG. 3, the database 310 may also include user data 314. FIG. 9 provides a more detailed view of the user data 314. As shown in the example provided in FIG. 9, the user data 314 typically includes client data 902 which is associated with enrollment services clients 222. The client data 902 may include the enrollment services client 222 name (e.g., the company name), the support contact person at the company, contact information and billing details. The client data 902 may also include the data specifying the individual users who access the system 210 on behalf of the enrollment services client 222 and their respective permissions. In addition, each enrollment services client 222 may also have a plurality of program profiles that it manages in the enrollment system 210. Accordingly, the client data 902 may also maintain information related to the each individual program profile, such as any image branding associated with the program profile, the card network, and the routing number associated with the issuer of the program. By maintaining this data, the enrollment services client 222 is able to analyze the performance of each of its specific programs individually.

The database 310 may also include event data 316. Event data 316 is data which relates to each action occurring within the direct deposit enrollment system 210 that impact the enrollments already in the system. Examples of events may include the editing of enrollment data 312, the receipt or reprocessing of return data 318 or entry of transaction notes 710 by an enrollment services client 222 or administrator 218. FIG. 10 provides a more detailed view of the event data 316. The event data 316 includes an event identifier 1002. The event identifier 1002 is a unique identifier that is assigned to each event that is recorded by the system 208. The event data 316 may also include an event type 1010. The event type 1010 which describes the type of event that took place. Examples of event types 1010 include single upload, batch upload, enrollment edit, enrollment packaging, enrollment return, and enrollment reprocess. The event data 316 may also include a user identifier 1004 which identifies the user which generated the event. Each event stored in the database 310 may also have an associated timestamp 1006. The timestamp data 1006 allows for sequencing and ordering of historical event data. The event may also include quantity data 1008. The quantity data 1008 relates to events that involve more than one detail. For example, a batch upload may upload 50 user enrollments. In the event data recorded for this particular upload, the quantity may be set to 50. In general, the event data is intended to provide detailed historical data that allows an administrator 218 to reconstruct system events over time.

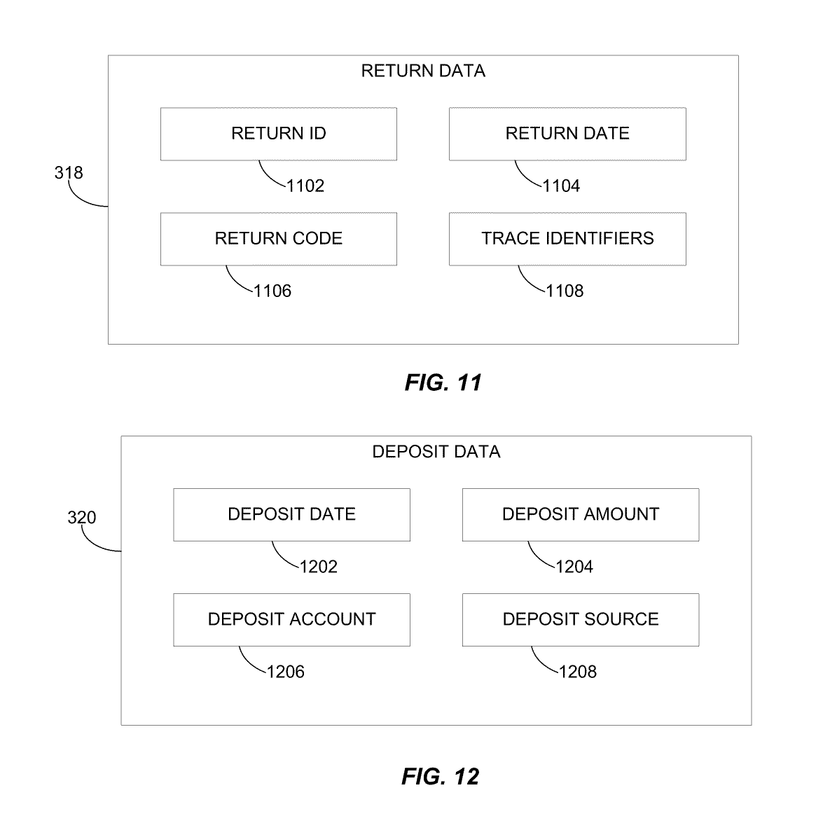

Also included in the database is return data 318. Return data 318 information relating to data that is received by the enrollment application server 308 from the payor 208 or an intermediary 214 in response to a requested enrollment. FIG. 11 provides a more detailed view of the return data 318. As shown, the return data 318 includes a return transaction identifier 1102. This identifier allows for the return information message to be uniquely identified. The return data 318 also may include a return date 1104 that indicates the date that the return message was received from the payor. The return data 318 typically also includes a return code 1106. In some embodiments, the return code may be an ACH message that indicates that some error occurred in an enrollment transaction. Other return codes may be used as appropriate in the specific context of the enrollment scenario. The return data also needs to be associated with an enrollment transaction. Thus, the return data also includes trace identifiers 1108 which provide identification of both the return itself and the enrollment transaction that it relates to. Once any errors in the return data 318 have been addressed, the enrollment transaction may be completed and direct depositing of funds may begin.

As noted above, the enrollment application server 308 may receive deposit data 320 from the issuing processor when direct deposits take place. FIG. 12 provides a more detailed view of the deposit data 320. As shown in the figure, the deposit data includes the deposit date 1202 and the deposit amount 1204, including zero-dollar pre-notes. A deposit transaction may also be associated with a deposit account 1206 as well as a deposit source 1208. In short, using the data received from the issuing processor 212, each direct deposit that results from an enrollment can be identified and associated with the payor 208, the payee 202, the related enrollment data 312 and any historical return data 318.

The database 310 also may undergo encryption processing 322 which is used to maintain the security of customer direct deposit enrollment transactions. In one embodiment, each user account is associated with a unique 32 character encryption key which is used to encrypt sensitive data (such as enrollment data 312, for example). These encryption keys may be stored in key storage. The sensitive data is generally stored encrypted to ensure its security. The encryption may be performed by an encryption script which incorporates a triple DES cipher. Because the encryption is user account specific, only the specific user account associated with the encrypted data can access the sensitive data.

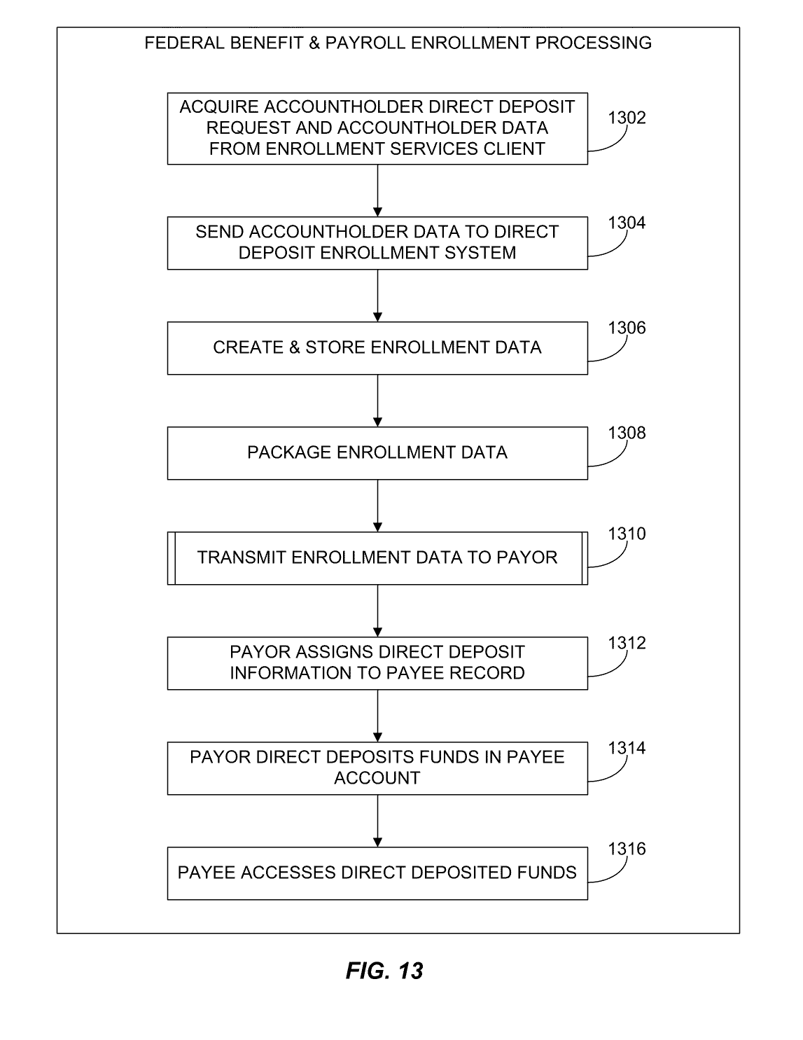

FIGS. 13-19 provide examples of various aspects of issuer-effectuated direct deposit enrollments that may be performed using the system described above. Turning to FIG. 13, a flowchart is provided which displays one example of a process for an issuer-effectuated enrollment using the direct deposit system disclosed herein. The process begins at step 1302, where a direct deposit request from the accountholder/payee 202 and the accountholder/payee data are obtained from the enrollment services client 222 responsible for the deposit account 204 associated with the accountholder/payee 202. Typically, the enrollment services client 222 obtains the data, but in some embodiments, the issuing processor 212 may obtain the data and provide it to the enrollment services client 222.

Next, the process moves to block 1304, where the enrollment services client sends the accountholder data to the direct deposit enrollment system 210. As noted previously, the enrollment services client 216 may access the direct deposit enrollment system 210 in various ways, including using a client API 402, a web-based entry form provided in a client portal, or though a batch entry interface that allows batch files of multiple enrollments to be uploaded and processed together. Alternatively, the issuing processor 212 having obtained the data, may transmit it directly via API 402 to the direct deposit enrollment system 210.

Once the accountholder data has been received by the enrollment system 210, the enrollment application server 308 creates the appropriate enrollment data and stores it in the enrollment data 312 of the database 310. As noted previously, the enrollment data may include accountholder data 602, program profile data 604, payment data 606 and transaction data 616. Once the enrollment data has been created by the application server 308, the process moves to block 1308, where the enrollment data is packaged for transmission to the payor 208 for enrollment.

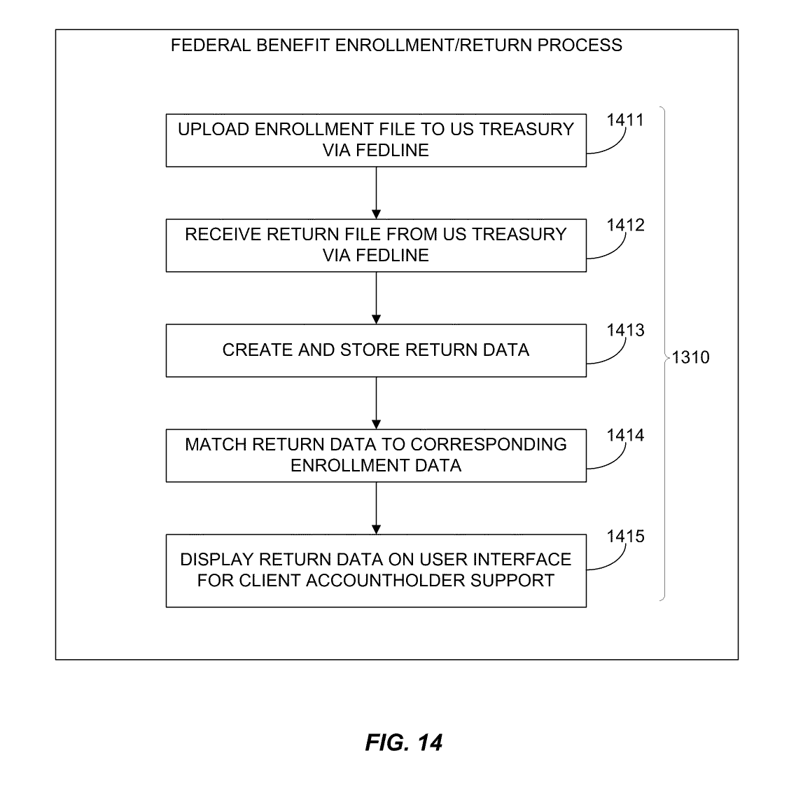

At block 1310, the enrollment data 312 is transmitted to the payor 208. As noted in the discussion of FIG. 5, depending on the type of payment and the type of payor involved, the enrollment data 312 will be transmitted differently. (FIGS. 14-17 provide the details of the different transmission methods.) Once the enrollment data has been transmitted to the payor 208, the processes the enrollment request by assigning the direct deposit information to the payee record in its system, thereby initiating direct deposit on the account. Once the direct deposit has been initiated, the payor 208 direct deposits funds into the deposit account 204 of the accountholder/payee 202 at block 1314. In some embodiments, an initial pre-note direct deposit will take place prior to any actual funds being direct deposited. The use of a pre-note can be helpful because it provides an indication to the enrollment system 210 that the enrollment was successful. Once the direct deposit has been made, the process then moves to block 1316, where the payee 202 accesses the funds in the deposit account 204.

As noted above, the nature of the payor 208 may govern the manner in which enrollment data is packaged and transmitted to the payor 208 to effectuate the direct deposit enrollment. FIG. 14 is a flowchart providing a more detailed view of how enrollment data is transmitted (as shown in block 1310 of FIG. 13) when the direct deposit relates to a federal benefit. The transmission process begins at block 1411, where the application server 308 uploads the packaged enrollment file to the U.S. Treasury 508 via the intermediary 214 Fedline 504. Treasury processes the enrollment and sends a return file via ACH. Next the process moves to block 1412, where enrollment application server 308 receives the return file. Upon receiving the return file, the application server 308 may then process the return file and create return data 318.

Next, the process moves to block 1414, wherein the return data 318 is matched to the corresponding enrollment data 1414. This matching may be achieved in a variety of ways. In one embodiment, the data is matched using trace identifiers from the transactions associated with the data. Once the appropriate enrollment data has been identified, the process then moves to block 1415. At block 1415, the return data is displayed on the user interface 408 for provide client accountholder support. If errors are identified in the return data (e.g., a return code indicates an error or inconsistency in the data), the enrollment services client can identify the error from the displayed data, correct the error and resubmit the updated enrollment data 1414 as necessary.

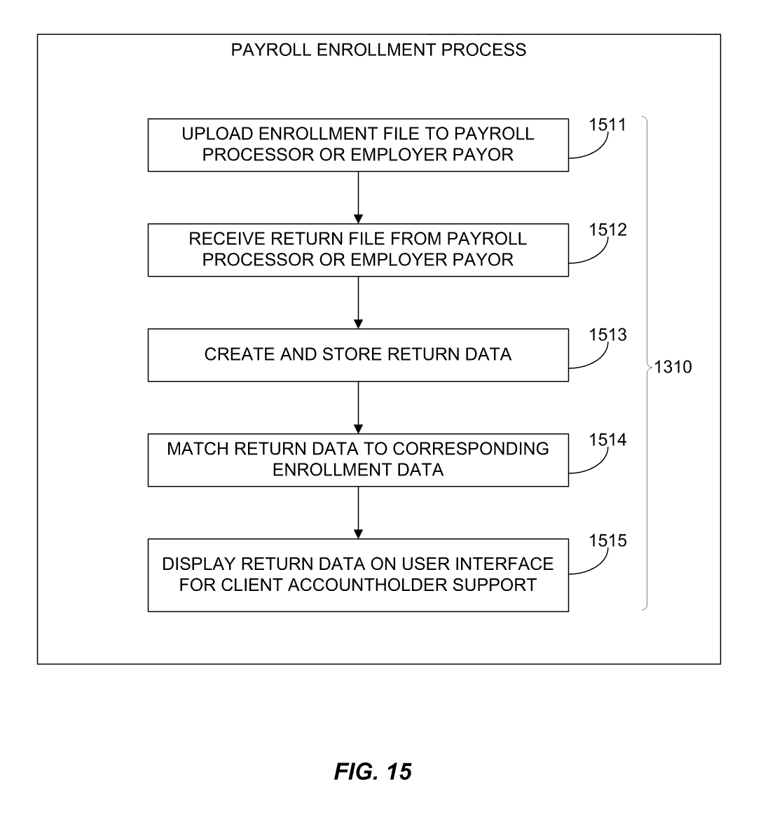

FIG. 15 is a flowchart providing a more detailed view of transmitting an enrollment to a payroll processor for direct deposit enrollment relating to a payment from an employer 506. As noted previously, the transmission method in this scenario significantly differs from the federal benefits scenario, and often involves a communication intermediary 214 such as a payroll processor 502. The process begins at block 1511, where the enrollment service client 216 uploads the enrollment file to either the payroll processor 502 (or the employer 506 if no payroll processor is used). As discussed above in connection with FIG. 5, this upload may be done via an API provided by the payroll processor 502. The payroll processor 502 may confirm the request data with the employer, and then sends a return file to the enrollment application server 308. Next, at block 1513, the enrollment application server processes the return file and creates and stores return data 318. The return data is then matched to the corresponding enrollment data 312 at block 1514. The process then moves to block 1515, where the return data 318 is displayed on the user interface 408 for enrollment services client 222 to provide accountholder/payee 202 support. If errors are identified in the return data 318, the enrollment services client 222 can identify the error from the displayed data, and resubmit the corrected enrollment data 312 as necessary.

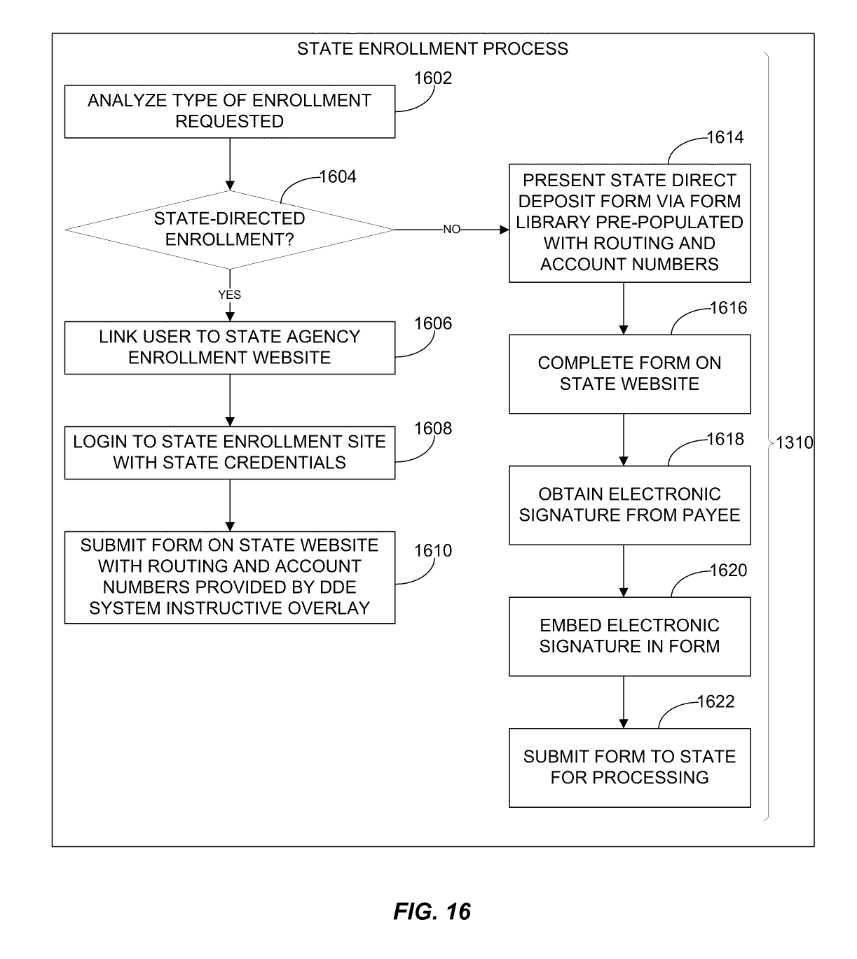

FIG. 16 provides another example of a transmission method for an enrollment process. In this particular example, the payor is a state agency 510. In this direct deposit scenario, the process includes additional complexity because various states have different requirements and protocols for direct deposit enrollment. The process begins at block 1602 where the application server 308 first determines whether the requested state enrollment is a state-directed enrollment or a non state-directed enrollment. The process moves to decision block 1604, where if the requested enrollment is a state-directed enrollment, the process moves to block 1606, where the accountholder/payee 202 is provided a link to the state enrollment website accompanied by an instructive overlay generated by the direct deposit enrollment system 210. In some embodiments, the instructive overlay provides the user with instructions for completing the state-directed direct deposit enrollment process, including the routing and account numbers prescribed to the accountholder/payee 202. The process next moves to block 1608, where the accountholder 202 accesses the state enrollment system using login credentials issued by the state. Once the user has logged into the state system, the process then moves to block 1610, where the accountholder 202 refers to the instructive overlay to enter the designated routing number and account number and submit the enrollment form.

If decision block 1604 determines that the requested state enrollment is not a state-directed enrollment, the process instead moves to block 1614, where the enrollment application server 308 presents a state direct deposit form generated from the forms library contained within the direct deposit enrollment system 210. In some embodiments, the direct deposit enrollment system 210 automatically loads the state form into a frame of the webpage, pre-populated with accountholder information, including the designated account and routing numbers. The user then completes the form on the state website at block 1616. Next the process moves to block 1618, where an electronic signature is obtained from the payee 202. In some embodiments, the payee 202 may be provided a web interface which allows it to input an electronic signature. Once the electronic signature has been obtained, it is embedded into the already completed state enrollment form at block 1620. From there, the process moves to block 1622, where the completed and signed form is submitted to the state for processing.

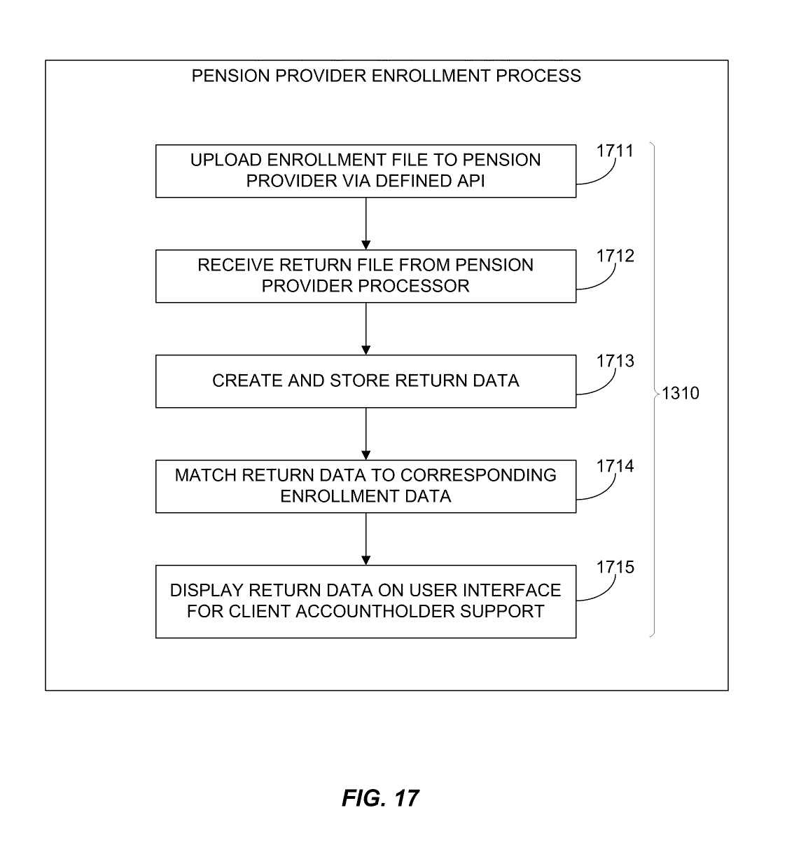

FIG. 17 is a flowchart providing a more detailed view of processing an enrollment relating to direct deposit of funds by a pension provider 512. The process begins at block 1711, where the enrollment file is uploaded via a defined API 402 to the pension provider 512. Next, a block 1712, the enrollment application server 308 receives a return file from the pension provider 512. It is to be appreciated that the pension provider may use a communication intermediary 512 (such as a payment processor) for purposes of issuing payments. However, in this example, the pension provider itself 512 handles the direct deposit enrollment. The pension provider 512 (or its processor intermediary) may confirm the request data and then sends a return file to the enrollment application server 308. Next, at block 1712, the enrollment application server receives and processes the return file. Once the return file has been received, the process moves to block 1713, where the enrollment application server 308 creates return data 318 and stores it in the database 310. Once the return data 318 has been stored, at block 1714, it is matched to the corresponding enrollment data 312 in order to identify the enrollment data 312 it corresponds to. The process then moves to block 1715, where the return data 318 is displayed on the user interface 408.

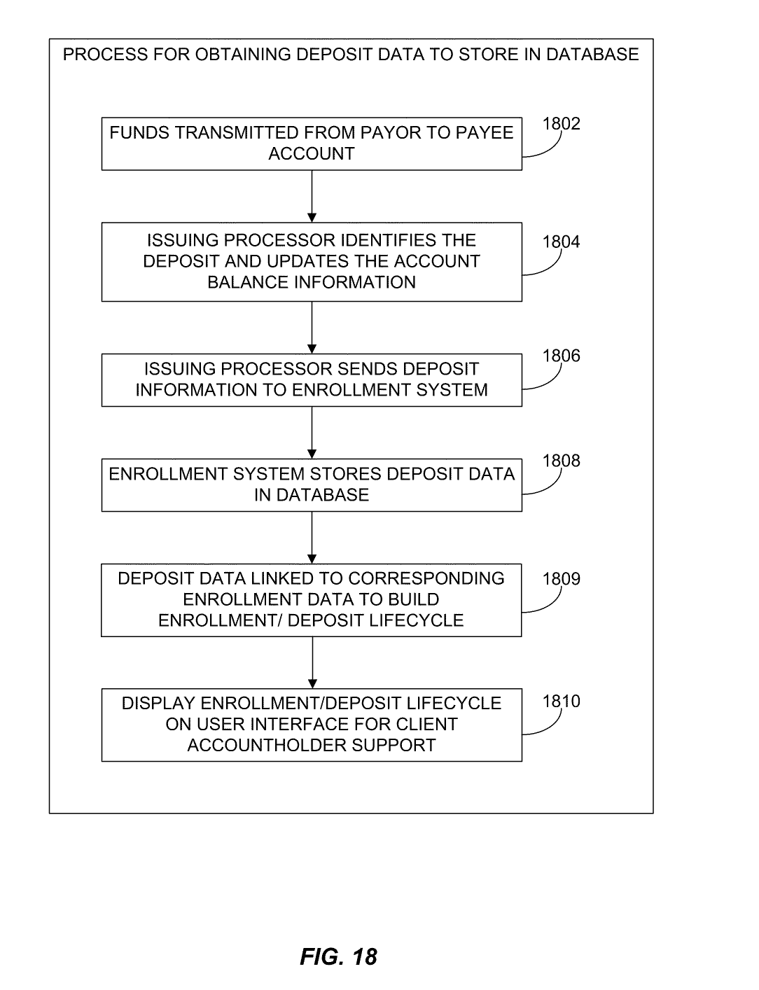

As noted above in connection with FIG. 3, the database 310 on the application server 308 may store deposit data 320. It has been recognized by the inventor that tracking deposit data 320 allows the enrollment system 210 to provide valuable data analysis to the enrollment services client 222. FIG. 18 provide one example of a process by which deposit data 320 can be collected in the enrollment system 210. The process begins at block 1802, where funds are transmitted from the payor 208 to the accountholder/payee 202 and deposited into the appropriate deposit account 204. Upon receiving the deposited funds, the issuing processor 212 identifies the deposit and updates the deposit account 204 information in accordance with the deposit at block 1804. The process then moves to block 1806, where the issuing processor 212 (or in some cases, the enrollment services client 222) sends the deposit information to the enrollment system 208 via the network 220. Next, at block 1808, the enrollment system 208 receives deposit information and stores it as deposit data 320 in the database 310.

Once the deposit data 320 has been stored, the process moves to block 1809, where the deposit data 320 is linked to the corresponding enrollment data 312 and any historical return data 318 in order to build an enrollment/deposit lifecycle dataset. This dataset provides detailed information about each deposit associated with a particular client enrollment. Once this information has been compiled, the process then moves to block 1810, where the information is displayed on the user interface 408 to the enrollment services client 222 for analysis and improved accountholder/payee 202 support.

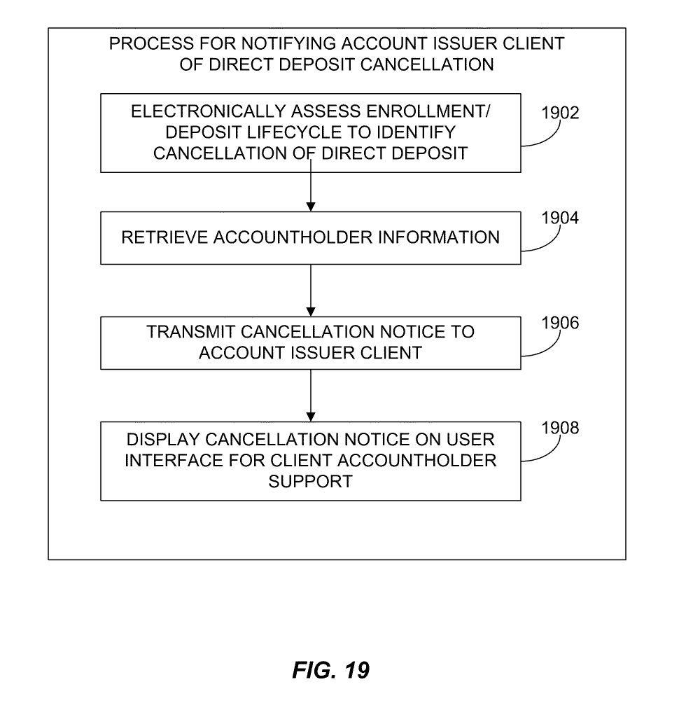

A key aspect of the invention relates to the ability of the enrollment system 210 to provide information about the behavior of the accountholder/payee 202 to the enrollment services client 222. FIG. 19 is flowchart showing process by which an enrollment services client 222 is notified that an accountholder/payee 202 has canceled a direct deposit enrollment. The process begins at block 1902, where the enrollment application server 308 analyzes the enrollment/deposit lifecycle of a payee 202 in order to identify a cancellation of direct deposit. Next, at block 1904, when a cancellation has been identified, the accountholder/payee information is retrieved for the accountholder/payee 202 associated with the cancelation. The cancelation notice is then transmitted to the enrollment services client 222 at block 1906. By receiving information about the cancelation notice, the enrollment services client 222 is provided an opportunity to proactively contact the payee 202 to find out the reason for the cancelation. Next, the process moves to block 1908, where the cancelation notice is displayed for viewing by the enrollment services client 222 on the user interface 408.

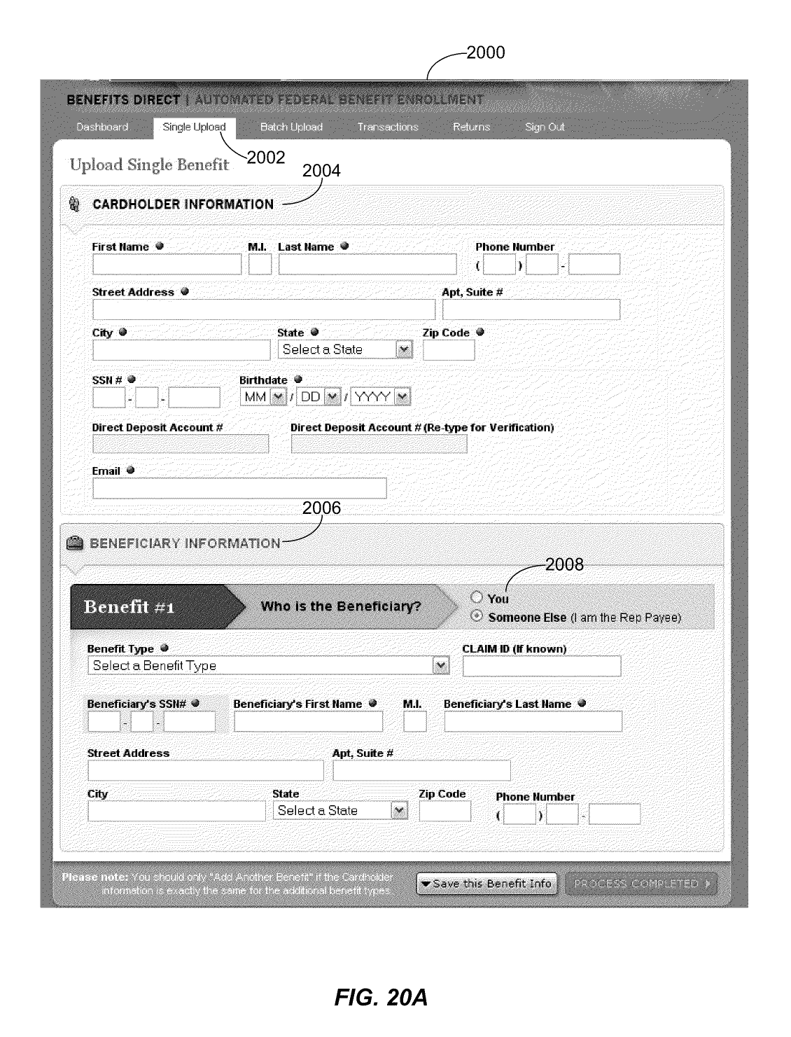

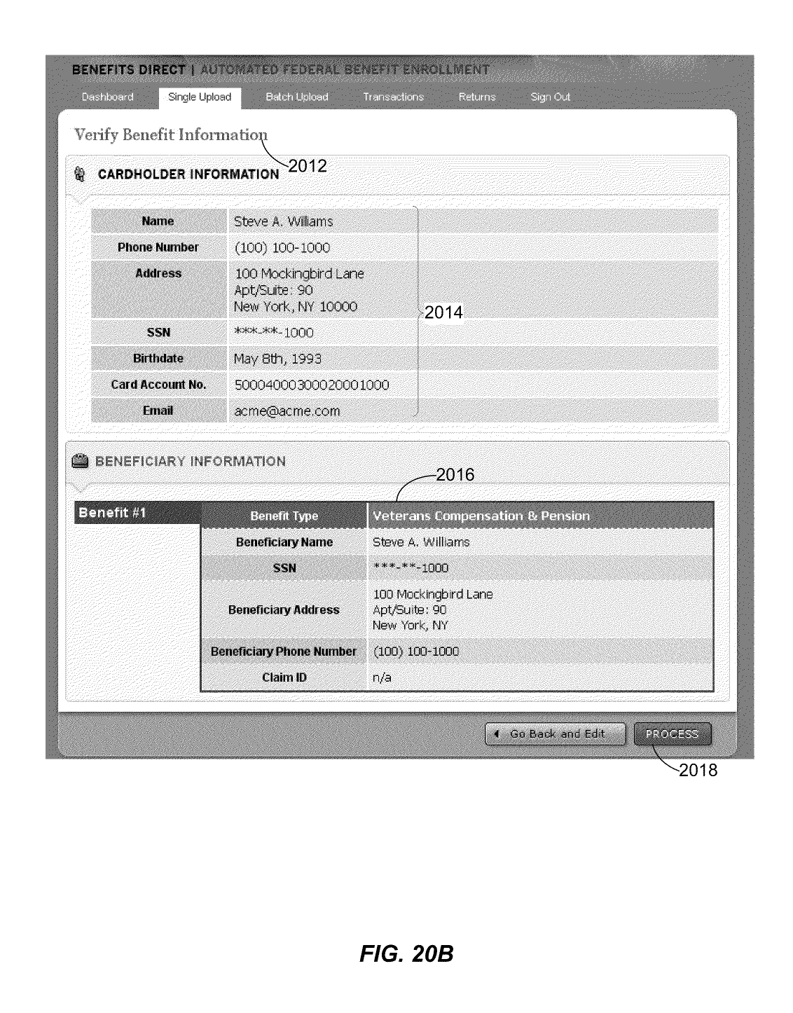

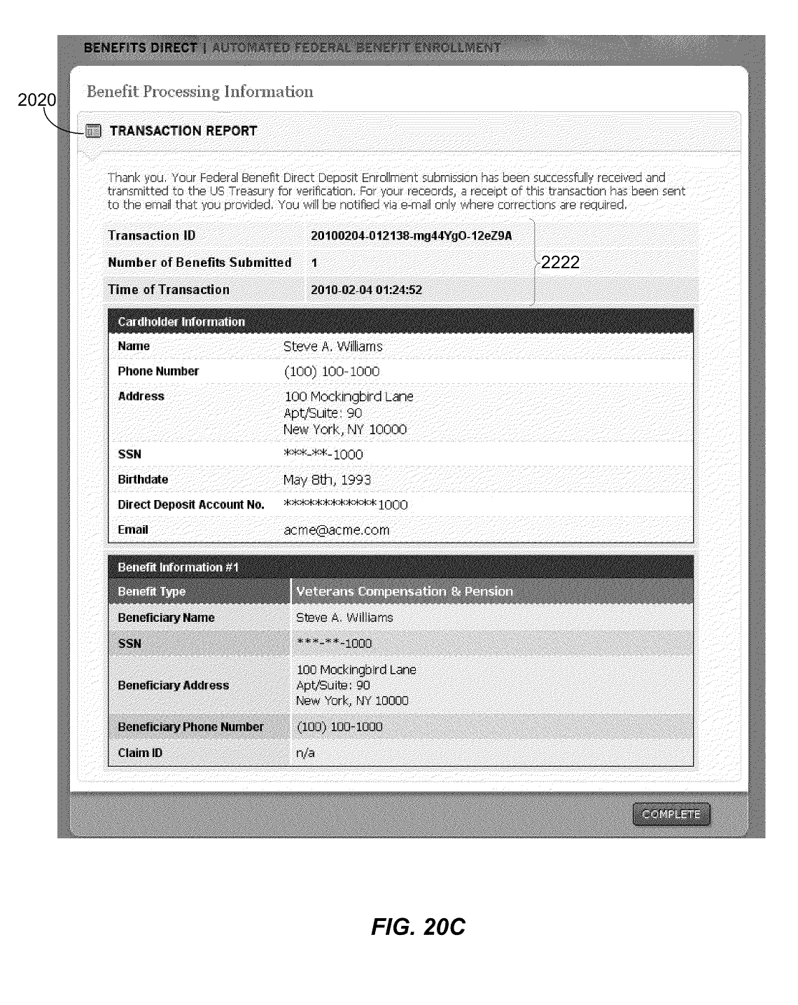

The systems and methods described thus far may be implanted in various ways. FIGS. 20-24 provide examples of user interfaces that may be used to practice in accordance with the embodiments described above.

Turning to FIG. 20A, an example is provided of a user interface 2000 for accountholder-assisted benefit enrollment by the enrollment services client 222. As shown, the user interface 2000 provides an input screen 2002 for a single upload of a direct deposit enrollment by the enrollment services client 222. In this particular example, the user interface 2000 is presented to the enrollment services client 222 as a webpage generated by the web server 306 and delivered via the network 220. The user interface 2000 includes two main areas: the accountholder (or cardholder) information area 2004 and the beneficiary information area 2006. In the cardholder information area 2004, the enrollment services client 222 may input the information about the accountholder/payee 202 as well as the account number associated with the accountholder's deposit account 204.

The beneficiary information area 2006 allows the user to input data regarding the specific benefit to be received. This portion of the interface allows the user to select the type of benefit, and well as input the beneficiary information. The beneficiary information area 2006 also includes a selection button 2008 which allows the user to indicate whether the beneficiary is the payee, or if the payee is a representative of the payee 202. Once all of the information has been input into the form, the form data may be submitted to the enrollment application server 308 where it is processed and stored as enrollment data 312 in the database 310.

FIG. 20B provides an example of verification user interface 2012 which is displayed to the user after the enrollment form has been submitted. The verification user interface displays the cardholder information 2014 entered in the previous screen, as well as the beneficiary information 2016. If the user finds any mistakes in the uploaded data, they may go back to the previous screen to edit the form. If, however, the data is accurate, the user may press the process button 2018, which causes the application server 308 to store the enrollment data in the database, package the enrollment data, and send the enrollment data to the appropriate payor 208 or communication intermediary 214 for processing.

Once the enrollment data has transmitted to the payor 208 (or communication intermediary 214), a transaction report may be provided to the user. FIG. 20C is an example of a transaction report 2020 according to one embodiment. As shown, the transaction report 2020 displays transaction data 2222 to the user, including a transaction identifier, the number of benefits submitted, and the time of the transaction. Additionally, the user interface displays the cardholder details and the benefit information submitted in the previous screen. The transaction data is generated when the user submits the form, and the generated transaction data is typically stored in the database 310.

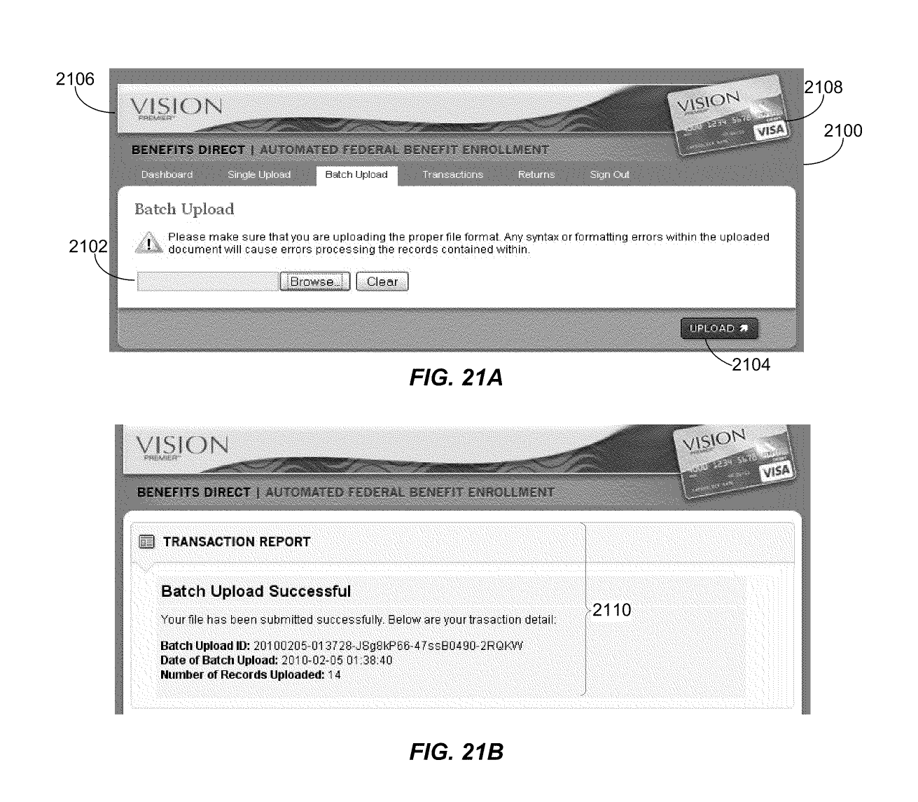

As noted above, in addition to submitting direct deposit enrollments seriatim, an enrollment services client 222 accessing the enrollment system 210 may also submit batch enrollments. FIGS. 21A and 21B provide an example of an upload interface for submitting a batch enrollment of multiple enrollments to the enrollment system 210. The upload interface 2100 includes a file input field 2102 which allows the user to specify the batch file to be uploaded. Once the batch file has been specified, the user may select the upload button 2104, which initiates the data upload. FIG. 21B provides a view of the user interface that is presented after a batch file has been successfully uploaded to the direct deposit enrollment system 210. As can be seen, like the single enrollment upload, the batch upload also generates a transaction in the database 310. A transaction report 2110 is displayed to the user to indicate that the upload was successful, with the assigned batch upload identifier included in the report. In the particular example shown, the uploaded batch file included 14 enrollments.

FIG. 21 also provides an example of program profile branding data 604. As shown in the figure, the heading of the user interface shows the program profile title 2106 (in this example “Vision Premier”) as well as an image of the specific debit card associated with the program 2108. Because a specific enrollment services client 222 may have multiple different programs, providing this visual indicator of the current program profile allows the user to easily confirm that they are using the correct interface.

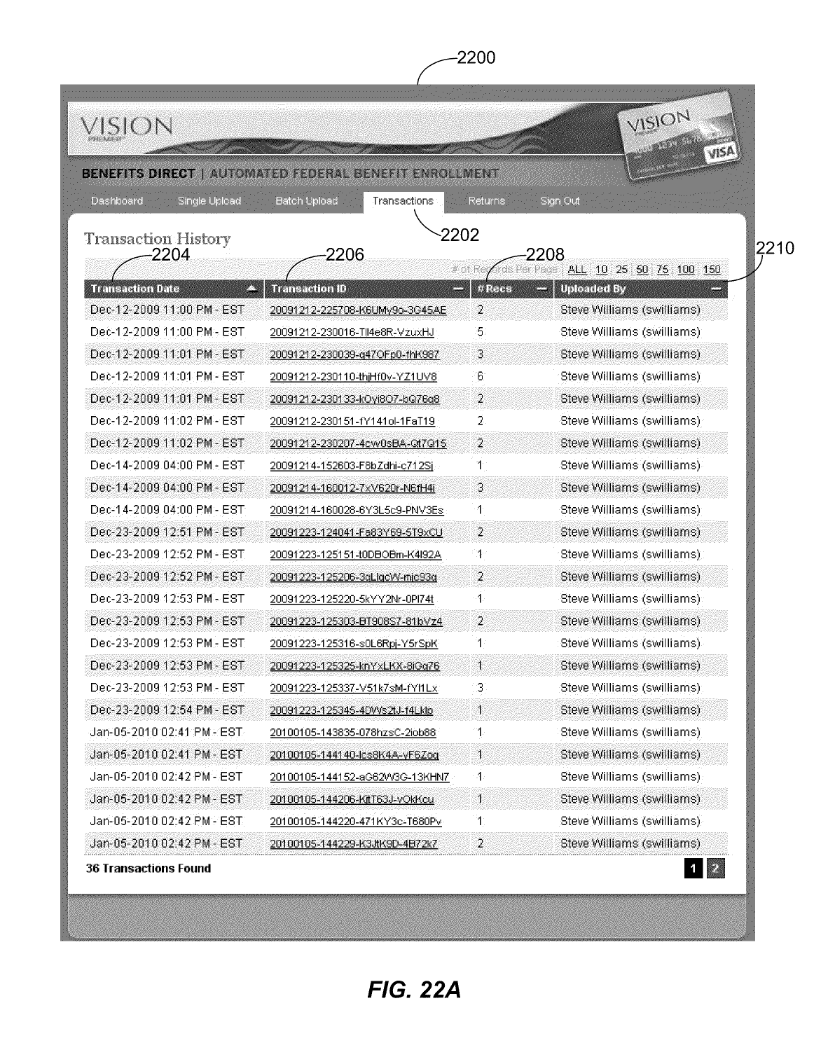

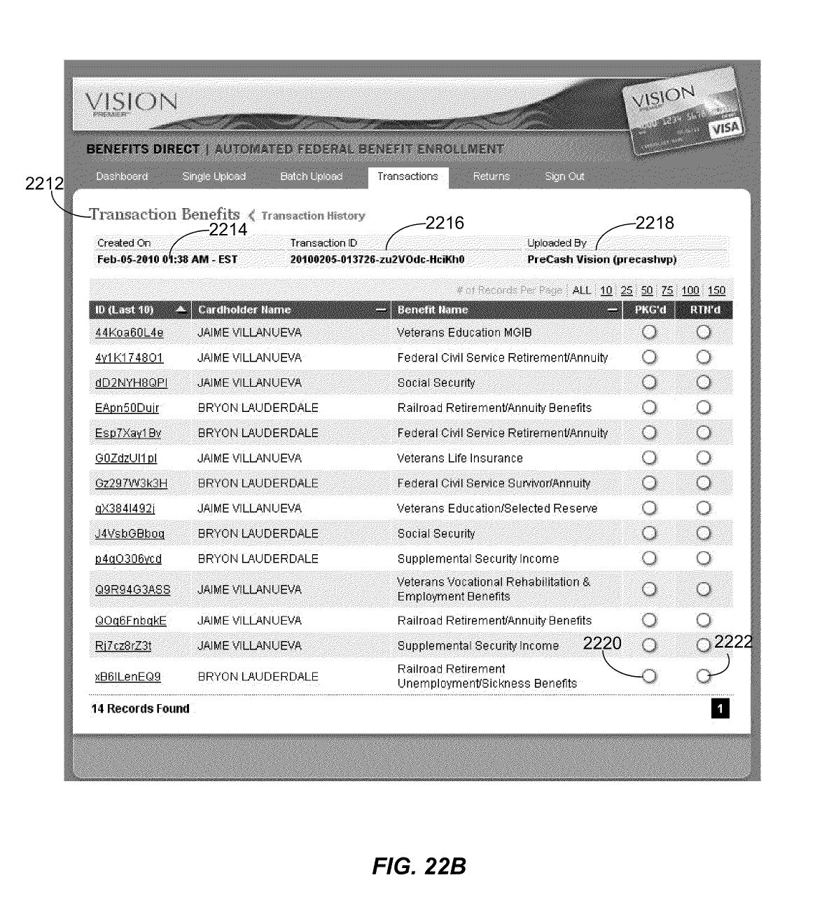

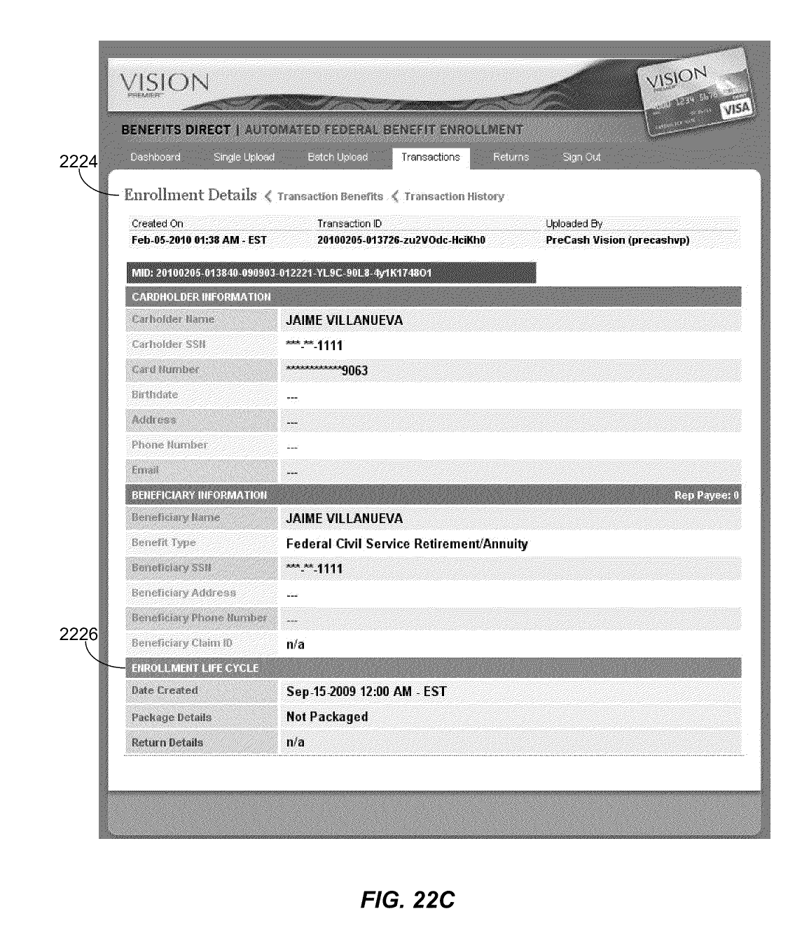

The user interfaces 408 made available via the direct deposit enrollment application server 308 also provide the enrollment services client 222 with the ability to manage and view their direct deposit enrollments. FIGS. 22A-22C provide an example of a user interface which provides this functionality. Turning to FIG. 22A, the transaction history interface 2200 is made available by selecting the transactions tab 2202 on the screen. When the transactions tab 2202 is selected, a sortable list of the transactions for the current program is provided for viewing. The transaction information displayed in the list includes the transaction date 2204, the transaction identifier 2206 assigned to each transaction, the number of records 2208 associated with the transaction (e.g., in cases of batch uploads), and the user 2210 who uploaded the transaction to the application server 308.

If the user wishes to view details about any of the transactions, they may select one of the transaction identifiers 2206 to view a transaction detail screen as provided in FIG. 22B. As shown, the transaction detail screen displays the date the transaction was created in the database 2214, the transaction identifier 2216, and the person 2218 whom uploaded the transaction. This interface also allows the enrollment services client 222 to see the enrollment/deposit lifecycle status of each of the enrollments associated with the transaction. In the example shown in FIG. 22B, a radio button 2220 indicates whether the enrollment has been packaged and sent to the payor 208. A second radio button 2222 indicates whether the payor 208 has return the enrollment (e.g., due to an error or some other reason). By providing this information, the enrollment services client 222 is able to easily see the status of each enrollment and know whether any issues have arisen.

If the user wishes to view additional details about any one of the enrollment records, they may select the identifier associated with that record to access an enrollment details interface. FIG. 22C provides an example of an enrollment details interface. In the example shown in FIG. 22C, the user has selected the second listed record from FIG. 22B. The enrollment details interface 2224 provides detailed information about the accountholder 202 and the beneficiary associated with the enrollment. In addition, it provides detailed information about the enrollment life cycle 2226. In the enrollment life cycle area 2226, the details of the return data 318 associated with this record are displayed for review by the user. If a return code indicates that the enrollment was not accepted for some reason, the enrollment services client may then correct the error and resubmit if necessary.

Utilizing the embodiments described above, a flexible and efficient method for direct deposit enrollment of accountholders is provided to account issuers. Nevertheless, those of skill will recognize that the various illustrative logical blocks, modules, circuits, and algorithm steps described in connection with the embodiments disclosed herein may be implemented as electronic hardware such as a general purpose or special purpose computer, computer software, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method of automating enrollment of direct deposits from a payor to a payee's deposit account, the method comprising:
receiving payee deposit account information from an enrollment services client;
generating direct deposit enrollment data from the received deposit account information;
storing the direct deposit enrollment data in a database;
packaging the stored direct deposit enrollment data for transmission to a payor; and
transmitting at least some of the enrollment data package to the payor.

2. The method of claim 1, wherein transmitting the enrollment data package to the payor comprises transmitting the enrollment data package to a communication intermediary for processing.

3. The method of claim 1, wherein packaging the stored direct deposit enrollment data comprises formatting the data in accordance with payor requirements for processing.

4. The method of claim 1, further comprising:
receiving data from the payor in response to the enrollment data package;
processing the received data and storing it as return data;
evaluating the return data to identify errors in the enrollment data package; and
modifying the enrollment data package to correct the identified errors; and
transmitting the modified enrollment data package to the payor.

5. The method of claim 1, further comprising:
receiving from an issuing processor data indicative of a zero dollar prenote direct deposit in the payee's deposit account; and
based on the data received from the issuing processor, updating the direct deposit enrollment data to indicate that the enrollment was successful.

6. The method of claim 1, further comprising:
receiving from an issuing processor, data indicative of a direct deposit into the payee's deposit account;
processing the received data and storing the received data as deposit data in the database; and
displaying, to the enrollment services client, a list of the deposits made into the payee's deposit account.

7. The method of claim 6, further comprising linking the stored deposit data to corresponding enrollment data stored in the database.

8. The method of claim 7, further comprising building an enrollment/deposit lifecycle from the linked data.

9. The method of claim 8, further comprising displaying the enrollment/deposit lifecycle on a user interface.

10. The method of claim 1, further comprising:
receiving a request from an enrollment services client to display each enrollment generated by the enrollment services client;
retrieving enrollment data based on the identity of the enrollment services client; and
displaying the enrollment data.

11. An issuer-effectuated direct deposit enrollment system for automating enrollment of direct deposits from a payor to a payee's deposit account, the system comprising:
an enrollment processing and verification module configured to:
receive accountholder/payee information from the enrollment services client and determine the type of payor from which direct deposit is sought;
store the accountholder/payee information as enrollment data;
generate a enrollment data package for transmission; and
transmit, based on the type of payor, the enrollment data package to the payor;
a return processing and verification module configured to:
receive data returned from the payor indicative of whether the payor successfully processed the enrollment data package;
process the received data and store the processed data as return data in a database; and
a deposit processing and verification module configured to:
receive, from an issuing processor, data indicative of a successful completion of a direct deposit into a deposit account; and
process the received data and store the processed data as deposit data; and
a server configured to:
retrieve the stored enrollment data, return data, and deposit data; and
execute computer instructions causing the retrieved data to be displayed to a user.
